(19) United States
(12) Patent Application Publication
(10) Pub. No.: US 2007/0151594 A1
(43) Pub. Date: Jul. 5, 2007

(54) One Piece, Collapsible PV Assembly

(75) Inventors: Gianluigi Mascolo, Danville, CA (US); Thomas L. Dinwoodie, Piedmont, CA (US)

Correspondence Address: HAYNES BEFFEL & WOLFELD LLP, P O BOX 366, HALF MOON BAY, CA, 94019, US

(73) Assignee: PowerLight Corporation, Berkeley, CA (US)

(21) Appl. No.: 11/617,109

(22) Filed: Dec. 28, 2006

Related U.S. Application Data
(60) Provisional application No. 60/754,912, filed on Dec. 29, 2005.

(51) Int. Cl. H02N 6/00

(52) U.S. Cl. 136/245

(57) ABSTRACT

A collapsible PV assembly comprises a PV module, a front support and a rear support assembly. The front and rear supports are secured to the front and rear edges of the PV module. The rear support assembly comprises a wind deflector assembly including a wind deflector which can be placed in a downwardly and outwardly extending use orientation and a storage orientation, extending along the lower surface of the PV module. In some embodiments the wind deflector assembly is pivotally connected to the PV module.

### CROSS-REFERENCE TO OTHER APPLICATIONS

This application claims the benefit of provisional patent application No. 60/754,912 filed 29 Dec. 2005 and entitled One Piece, Collapsible PV Assembly.

### STATE SPONSORED RESEARCH OR DEVELOPMENT

This invention was made with State of California support under the California Energy Commission Agreement Number 500-00-034. The Energy Commission has certain rights to this invention.

### BACKGROUND OF THE INVENTION

Air moving across an array of photovoltaic (PV) assemblies mounted to the roof of a building, or other support surface, creates wind uplift forces on the PV assemblies. Much work has been done in the design and evaluation of arrays of PV assemblies to minimize wind uplift forces. See U.S. Pat. Nos. 5,316,592; 5,505,788; 5,746,839; 6,061,978; 6,148,570; 6,495,750; 6,534,703; 6,501,013 and 6,570,084. Reducing wind uplift forces provides several advantages. First, it reduces the necessary weight per unit area of the array. This reduces or eliminates the need for strengthening the support surface to support the weight of the array, thus making retrofit easier and reducing the cost for both retrofit and new construction. Second, it reduces or eliminates the need for the use of roof membrane- (or other support surface-) penetrating fasteners; this helps to maintain the integrity of the membrane. Third, the cost of transporting and installing the assembly is reduced because of its decreased weight. Fourth, lightweight PV assemblies are easier to install than assemblies that rely on heavy ballast weight to counteract wind uplift forces. Fifth, when appropriately designed, the assembly can serve as a protective layer over the roof membrane or support surface, shielding from temperature extremes and ultraviolet radiation.

PV assemblies can be mounted flat on a roof or other support surface or at an angle to support surface. The rear edge of the PV module (the polar edge, that is the north edge in the northern hemisphere) is commonly supported above the support surface by a rear support. The rear support may be pivotally connected to the PV module. See, for example, U.S. Pat. Nos. 6,046,399; 6,534,703 and 6,809,251.

### BRIEF SUMMARY OF THE INVENTION

One example of a collapsible PV assembly comprises a PV module, a front support and a rear support assembly. The PV module comprises front and rear edges on opposite sides thereof, an upper surface and a lower surface. The front support is secured to the PV module at the front edge and has a first support-surface-engaging surface. The rear support assembly comprises a wind deflector assembly having first and second end portions, the wind deflector assembly comprising a wind deflector. The rear support assembly also comprises a connection securing the first end portion to the PV module at the rear edge to permit the wind deflector assembly to be placed in a use orientation, extending downwardly and outwardly away from the rear edge, and a storage orientation, extending along the lower surface of the PV module. The second end portion of the wind deflector assembly comprises a second support-surface-engaging surface. In some embodiments the connection may comprise a pivot connection pivotally securing the first end portion of the wind deflector assembly to the PV module at the rear edge, whereby the one-piece, collapsible PV assembly is a one-piece, folding PV assembly. In some embodiments the front support may be pivotally connected to the PV module for movement between a use orientation, extending outwardly away from the front edge, and a storage orientation, extending along the lower surface of the PV module. In some embodiments the PV module may comprise a peripheral edge, the peripheral edge and the lower surface defining a PV module interior, the rear support assembly being effectively completely within the PV module interior when the wind deflector assembly is placed in the storage orientation. In some embodiments rows of PV assemblies may have side wind deflectors at the ends of the rows.

An example of a method for installing an array of PV assemblies on a support surface comprises receiving a plurality of folded PV assemblies at a worksite in folded, storage orientations and transforming at least one of said PV assemblies from a storage orientation to a use orientation. The PV assemblies each comprise a PV module having a lower surface, a front support and a rear support assembly comprising a wind deflector, the rear support assembly pivotally connected to the PV module and extending along the lower surface of the PV module in the storage orientation. Transformation from the storage orientation to the use orientation includes pivoting the rear support assembly downwardly and outwardly away from the lower surface of the PV module, arranging the front support to extend outwardly away from the PV module, and positioning said at least one PV assembly in the use orientation on the support surface. In some embodiments the receiving step comprises receiving the plurality of one-piece folded PV assemblies with the front support pivotally connected to the PV module and extending along the lower surface in the storage orientation, and the transforming step comprises pivoting the front support downwardly and outwardly away from the PV module. In some embodiments the receiving step is carried out with the PV module having a peripheral edge, the peripheral edge and the lower surface defining a PV module interior, and the rear support assembly is effectively completely within the PV module interior when in the storage orientation.

An example of a method for preparing and installing an array of PV assemblies on a support surface may proceed as follows. A plurality of PV modules is shipped in packaging. The PV modules are removed from the packaging, PV assemblies are repackaged in the packaging in a folded, storage orientation, the PV assemblies each comprising said PV module and a rear support assembly comprising a wind deflector. The rear support assembly is pivotally connected to the PV module and extends along the lower surface of the PV module in the storage orientation. The PV assemblies are transported in the same packaging used for shipping the PV modules. A plurality of the transported PV assemblies is received at a worksite in the folded, storage orientations. The PV assemblies are removed from the packaging. At least one of the PV assemblies is transformed from the folded, storage orientation to an unfolded, use orientation by pivoting the rear support assembly downwardly and outwardly away from the lower surface of the PV module, and arranging a front support to extend outwardly away from the PV module. The at least one PV assembly is positioned in the use orientation on the support surface. In some embodiments a plurality of the PV assemblies may be arranged to form an array of PY assemblies on the support surface. In some embodiments the PV assemblies of the array of PV assemblies are secured to one another using, for example, connector elements. In some embodiments connector means may be used to prevent lateral separation between adjacent PV assemblies while permitting said PV assemblies to follow the contour of an other-than-flat support surface.

An example of a one-piece, nesting PV assembly comprises a PV module comprising front and rear edges on opposite sides thereof, an upper surface and a lower surface. A front support is secured to the PV module at the front edge, the front support having a first support-surface-engaging surface, the front support extending outwardly away from the front edge. A rear support assembly comprises any wind deflector assembly having first and second end portions, the wind deflector assembly comprising a wind defector. The second end portion of the wind deflector assembly comprises a second support-surface-engaging surface. The first end portion is secured to the PV module at the rear edge, the rear support assembly extending downwardly and outwardly away from the rear edge. The PV assembly has complementary nestable top and bottom surface profiles to permit first and second of the PV assemblies to stack in a nesting fashion in a transport mode with the PV module, front support and rear support assembly of the first PV assembly adjacent to the corresponding structure of the second PV assembly thereby maximizing packing density.

One aspect of the present invention is the recognition that there are substantial advantages to be gained from designing a one-piece, collapsible PV assembly that can be shipped to an installation site and mounted directly to a roof or other support surface without the need to assemble the major components, including the rear wind deflector, of the PV assembly, the installation capable of being carried out using simple tools in a straightforward installation process. Another aspect of the present invention is the recognition that there are significant advantages arising from shipping the PV assemblies in a compact folded state, especially where the PV assembly can be shipped in the same shipping container as the PV module.

Various features and advantages of the invention will appear from the following description in which the preferred embodiments have been set forth in detail in conjunction with the accompanying drawings.

### BRIEF DESCRIPTION OF THE DRAWINGS

FIG. 1 is an overall view of a portion of a PV installation including interconnected rows of PV assemblies;

FIG. 2 is an enlarged view of a portion of the PV installation of FIG. 1;

FIG. 3 is a side view of the structure of FIG. 2;

FIG. 4 is a view similar to that of FIG. 2 but with the rear wind deflector removed to show detail;

FIG. 5 is a view of the structure of FIG. 2 illustrating the connection of the front supports to the PV modules;

FIG. 6 is an enlarged view of a portion of the structure of FIG. 4 with adjacent PV modules secured to one another using a connector element;

FIG. 7 illustrates two of the PV assemblies of FIGS. 1-3 in a shipping or storage orientation with the rear support assemblies folded back and extending along the lower surface of the PV module and with the front supports removed;

FIGS. 8-10 illustrate a portion of an alternative embodiment of the invention in which the front support is secured directly to the lower edge of the rear wind deflector;

FIG. 11 is a side view of another alternative embodiment of invention, the view being similar to that of FIG. 3;

FIG. 12 is an enlarged view of a portion of the structure of the FIG. 11;

FIG. 13 is a partial isometric view of a portion of the structure of FIG. 12;

FIG. 14 is a partial isometric view of the structure of FIG. 13 looking upwardly towards the lower surfaces of the rear wind deflectors and PV module;

FIG. 15 is an upwardly viewing isometric view of the front support of FIG. 11;

FIG. 16 is an upwardly viewing isometric view of the front support of FIG. 15 in a storage orientation within the PV module interior;

FIG. 17 is a side view of the rear support assembly of FIG. 11 in a storage orientation within the PV module interior;

FIG. 18 is a side view of a further alternative embodiment of invention similar to the embodiment of FIG. 11; and

FIG. 19 is a side view of a still farther alternative embodiment shown in a nesting, transport mode.

### DETAILED DESCRIPTION OF THE INVENTION

The following description of the invention will typically be with reference to specific structural embodiments and methods. It is to be understood that there is no intention to limit the invention to the specifically disclosed embodiments but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

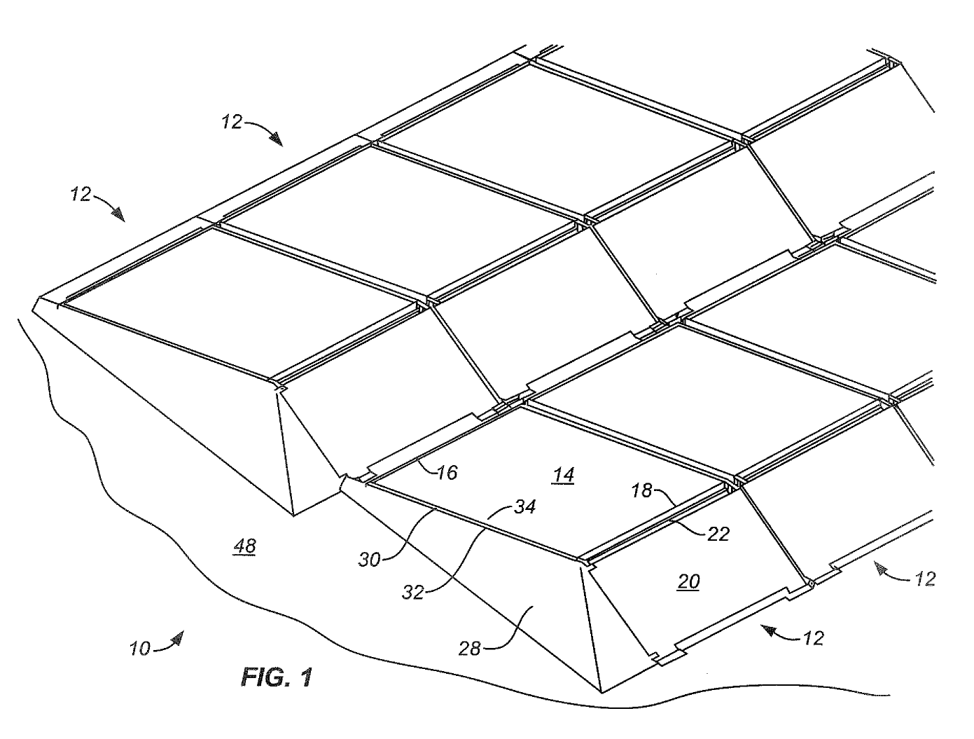

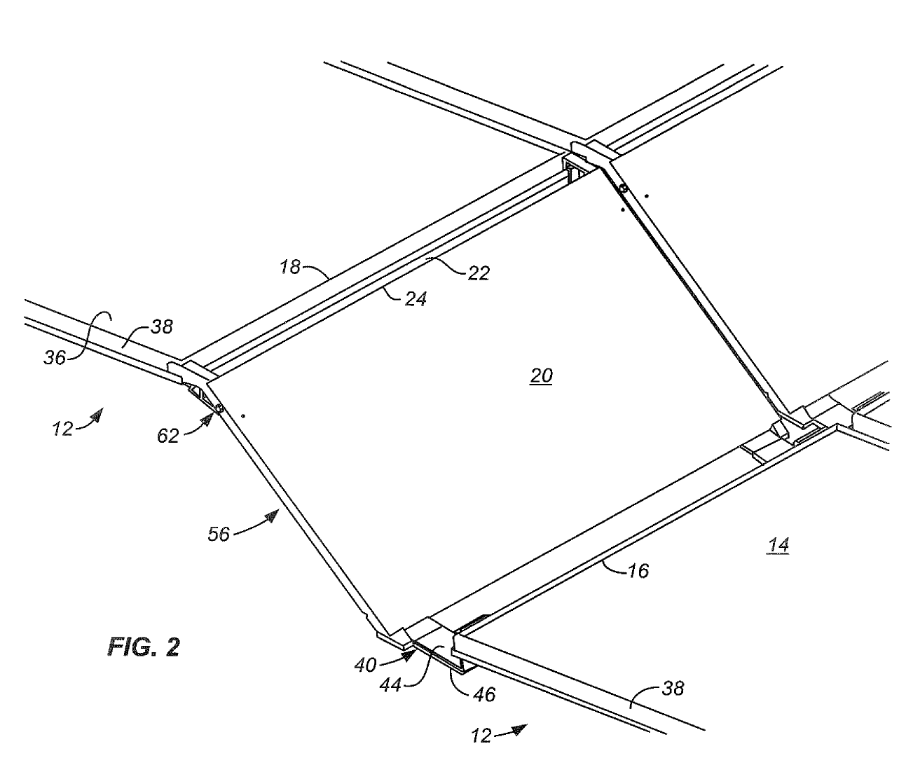

FIGS. 1 and 2 disclose a PV installation 10 including an array of one-piece, collapsible PV assemblies 12. Assemblies 12 each include a sloped PV module 14. Sloped PV modules 14 are typically oriented to face the sun. That is, in the northern hemisphere, the lower, front edge 16 of PV module 14 may be considered the lower, south or equatorial edge, while the upper, rear edge 18 of PV module 14 may be considered the upper, north or polar edge. In the southern hemisphere, lower, front edge 16 may be considered the lower, north or equatorial edge while upper, rear edge 18 may be considered the upper, south or polar edge. The angle of tilt may be fixed or adjustable. In some embodiments of the invention the angle of tilt is about 1°-35° while in other embodiments the angle of tilt is about 1°-20°.

Each PV assembly 12 preferably includes a rear wind deflector 20 extending downwardly and outwardly away from upper, rear edge 18 PV module 14. A gap 22 is provided between rear edge 18 and the upper edge 24 of rear wind deflector 20. Side wind deflectors 28 are used at the end of each row of PV assemblies 12. A gap 30 is preferably provided between the upper edge 32 of side wind deflector 28 and the outside lateral edge 34 of PV module 14. The use of wind deflectors 20, 28 and the provision of gaps 22, 30 are discussed in more detail in U.S. Pat. No. 6,570,084 and in International patent application PCT/004/27351 published 3 Mar. 2005 as International Publication Number WO 2005/02090, the disclosures of which are incorporated by reference.

PV module 14, in this embodiment, includes a main body 36 surrounded by a peripheral edge 38. Peripheral edge 38 is typically extruded aluminum but may also be made of other metals or appropriate nonmetallic materials as well. Peripheral edge 38 helps to protect main body 36 and also provides structural strength to PV module 14. In addition, front and rear support structures of PY assembly 12, discussed below, are secured to peripheral edge 38 to eliminate the need to secure such support structures directly to main body 36 of PV module 14.

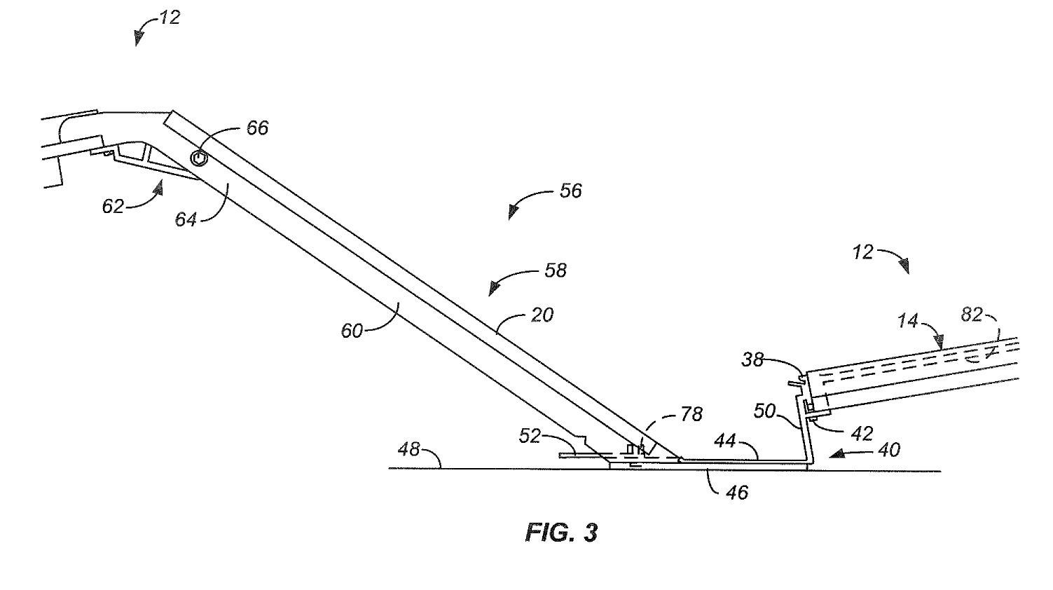

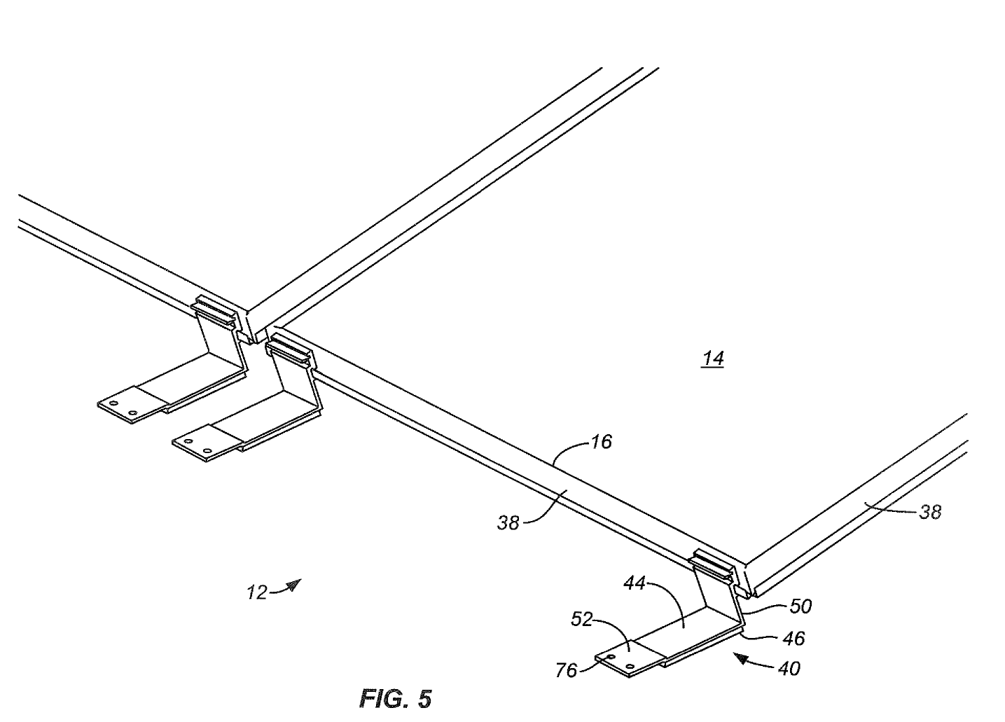

PV assembly 12 also includes a front support 40 secured to and extending from peripheral edge 38 at either end of front edge 16. This is typically accomplished using screws 42, as shown in FIGS. 3 and 5; other appropriate fasteners may also be used. In addition, front support 40 and peripheral edge 38 may be configured to permit front support 40 to be secured to the peripheral edge without the use of tools. Front support 40 includes a base 44 having a pad 46 on its lower surface, pad 46 resting on the roof or other support surface 48 on which PV installation 10 is supported. Support surface 48 is typically horizontal, but may be inclined as well. Front support 40 also includes an upwardly extending arm portion 50, see FIG. 3, secured to peripheral edge 38. Base 44 includes an offset distal end 52 configured to engage the rear support structure of an adjacent PV assembly 12.

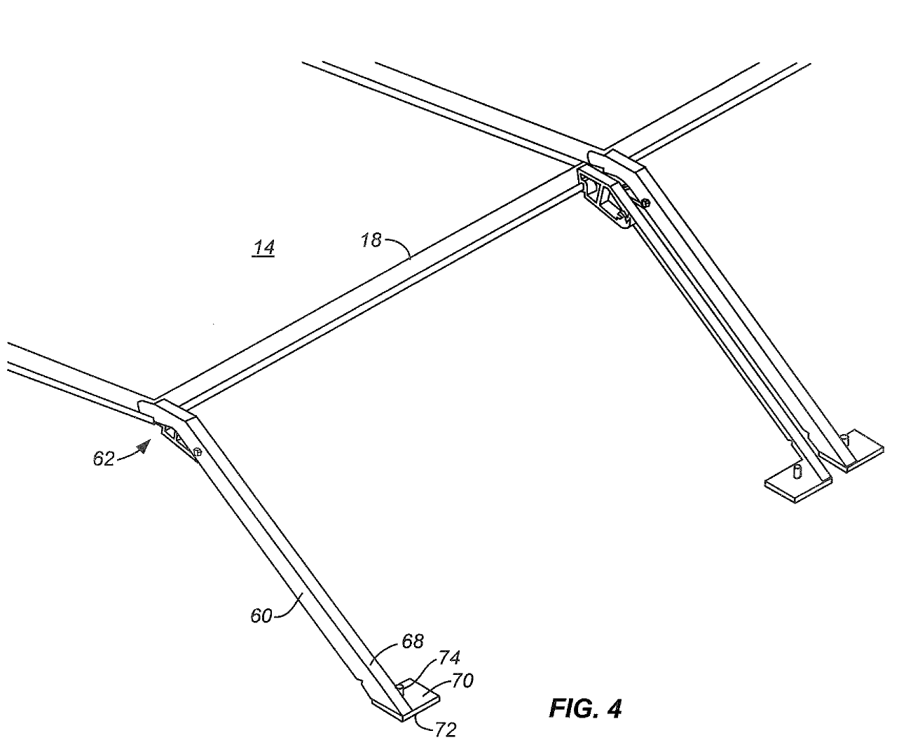

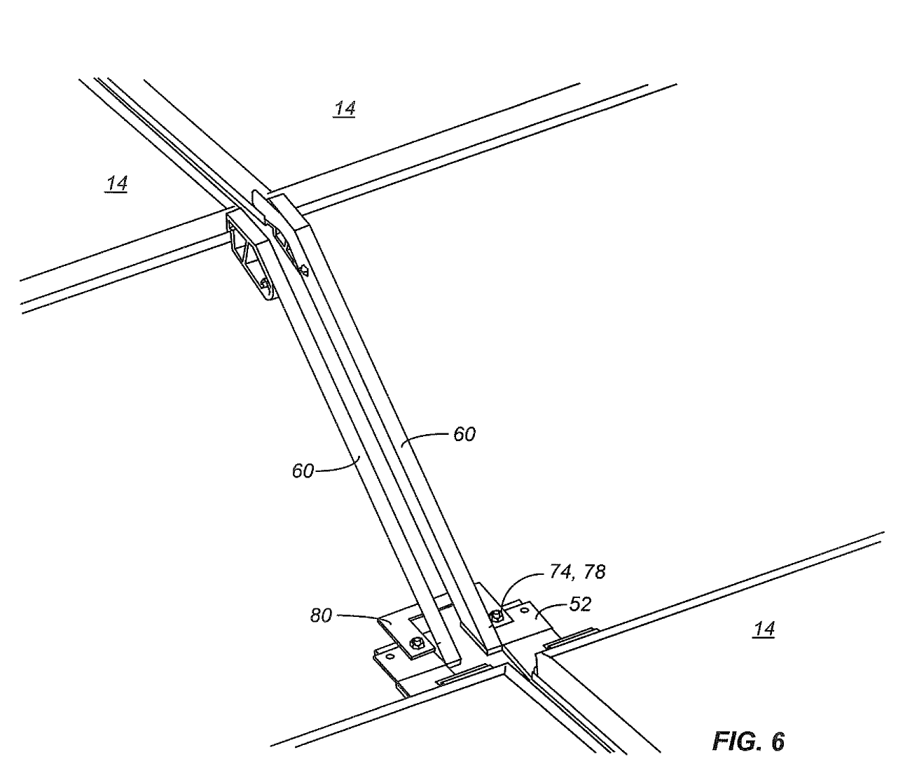

PV assembly 12 also comprises a rear support assembly 56 secured to peripheral edge 38 at each end of rear edge 18. Rear support assembly 56 comprises a wind deflector assemble 58, assembly 58 comprising rear wind deflector 20 secured to legs 60. Rear support assembly 56 also includes connections 62 extending from peripheral edge 38. Connections 62 pivotally connect the upper ends 64 of legs 60 to PV assembly 12 for pivotal movement about pivots 66. The lower end 68 of each leg 16 includes a foot 70, see FIG. 4, below which a pad 72 is secured. Pad 72 rests on support surface 48. A threaded stud 74 extends outwardly from foot 70 and is used to pass through a hole 76, see FIG. 5, in offset distal end 52 of front support 40 of an adjacent PV assembly 12. A nut 78, shown in FIGS. 3 and 6, is used on stud 74 to secure front support 40 to rear support assembly 56.

A connector element 80 is used to secure adjacent PV assemblies 12 to one another at their adjacent corners to help maintain the PV assemblies in place and also to help installation 10 counteract wind uplift forces. The advantages associated with connecting adjacent PV assemblies to one another are discussed in more detail in U.S. Pat. No. 6,570,084 and in International patent application PCT/004/27351 published 3 Mar. 2005 as International Publication Number WO 2005/02090, the disclosures of which are incorporated by reference. Connector element 80 is preferably constructed to prevent lateral separation between the adjacent PV assemblies 12 but is flexible enough to permit the PV assemblies to follow the contour of an other-than-flat support surface.

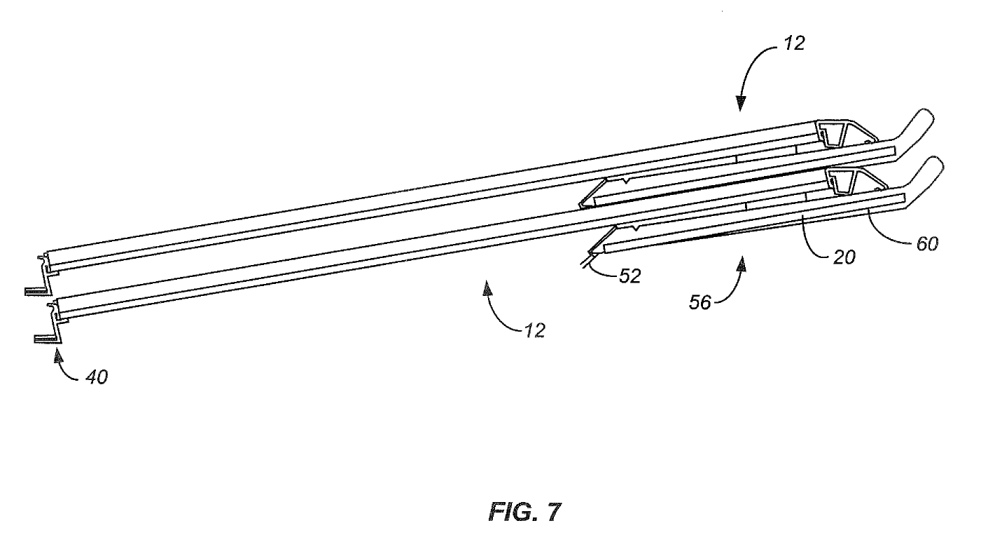

FIGS. 1-6 illustrate PV assembly 12 in the use configuration with rear wind deflector 20 extending downwardly and outwardly away from rear edge 18 of PV module 14. The use of the connections 62 permits rear support assembly 56, including legs 60 and rear wind deflector 20, to be folded back so that assembly 56 extends along the lower surface 82 (see FIGS. 3 & 16) of PV module 14 in a storage orientation. As shown in FIG. 7, the folded, storage orientation provides an effective, space-saving way to store and ship PV assemblies 12. In the embodiment of FIGS. 1-6, front supports 40 are secured to peripheral edge 38 for shipping and storage; front supports 40 may also be detached from peripheral edge 38 for shipping and storage.

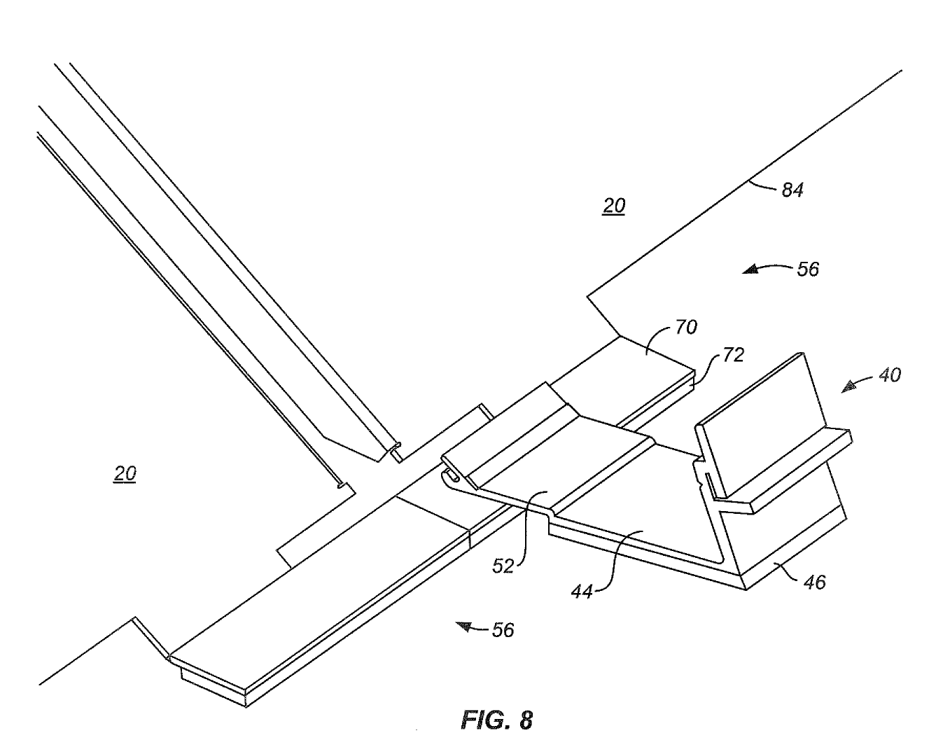

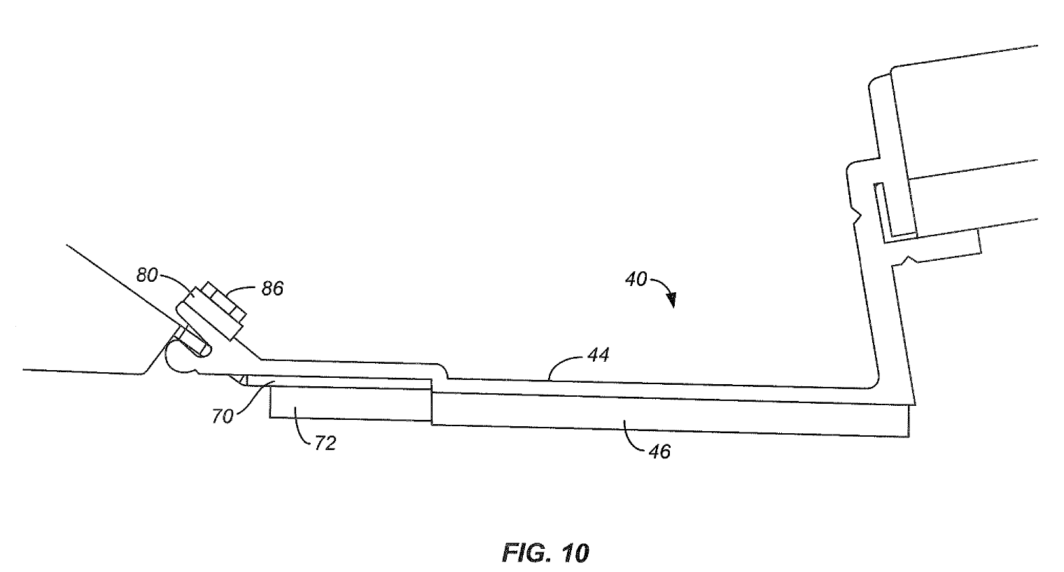

FIGS. 8-10 illustrate portions of an alternative embodiment of the invention with like reference numerals referring to like elements. In this embodiment foot 70 extends from the lower edge 84 of rear wind deflector 20. Offset distal end 52 of front support 40 clips directly to lower edge 84 and is secured in place using connector element 80 and screws 86.

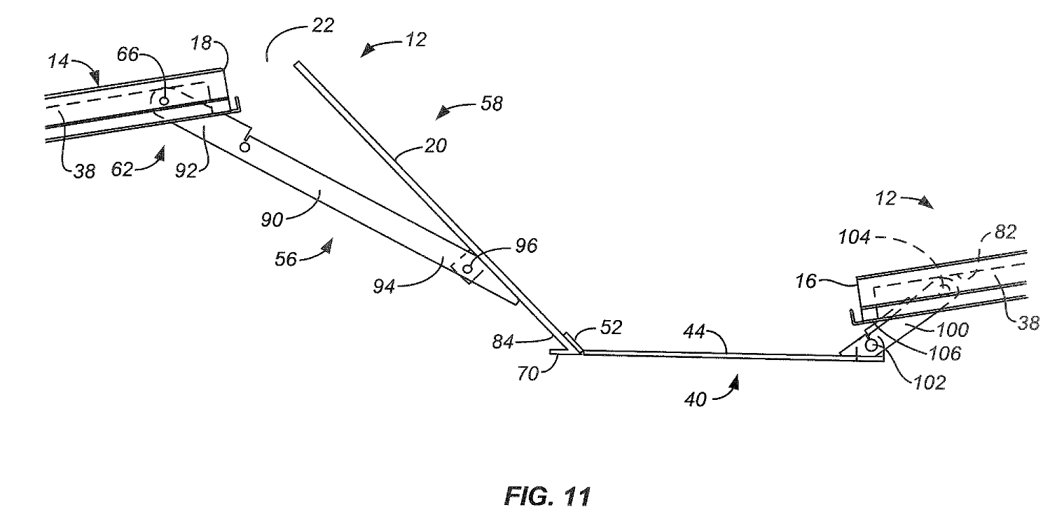

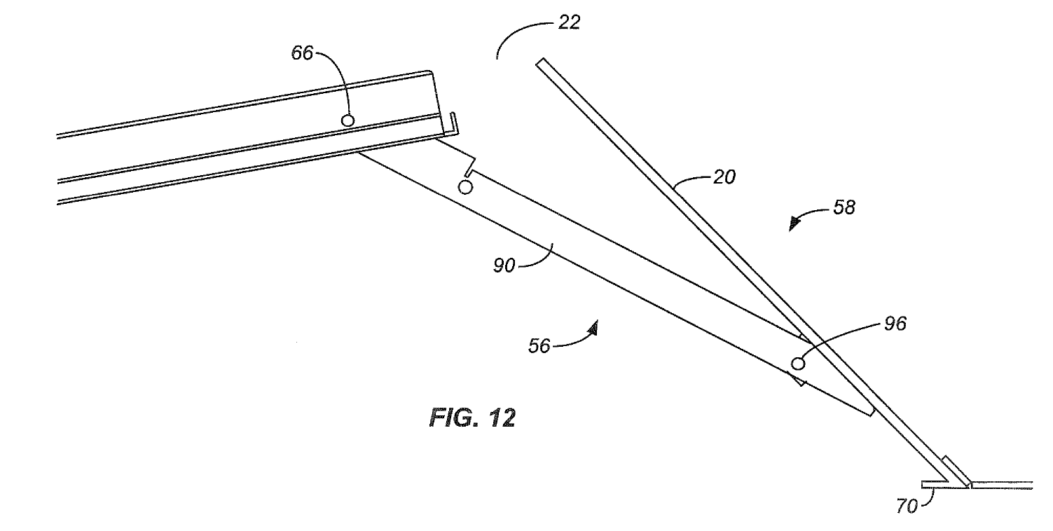

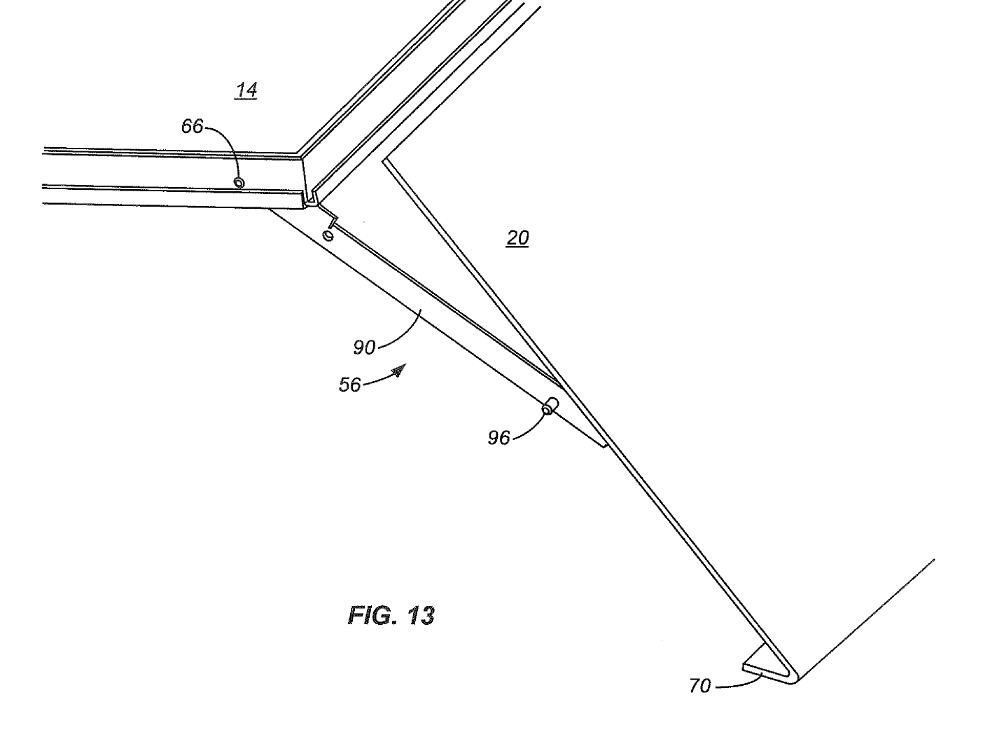

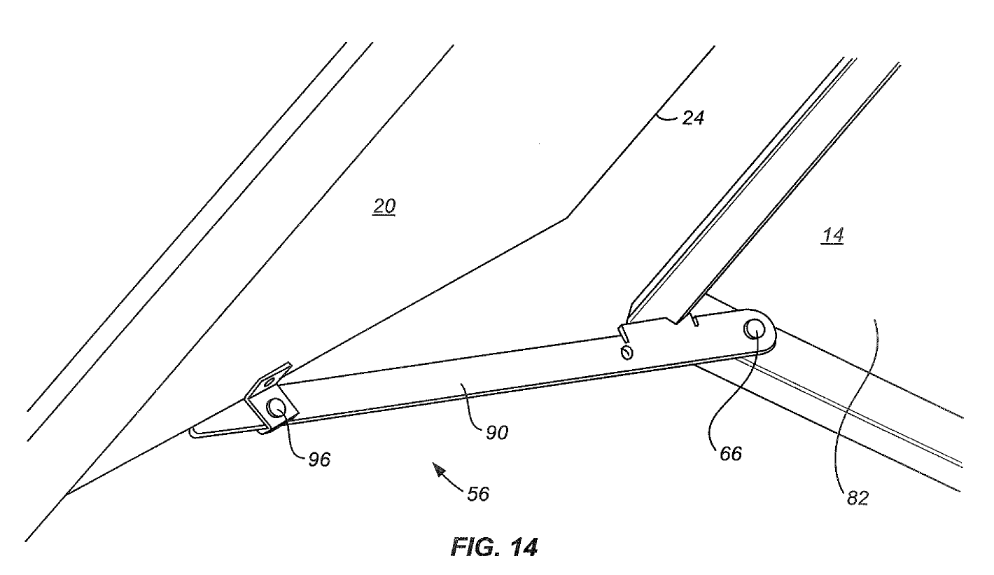

FIGS. 11-17 illustrate a further embodiment of the invention with like reference numerals referring to like elements. PV assembly 12 is configured so that support assembly 56 is nested within PV module 14 when in a storage orientation.

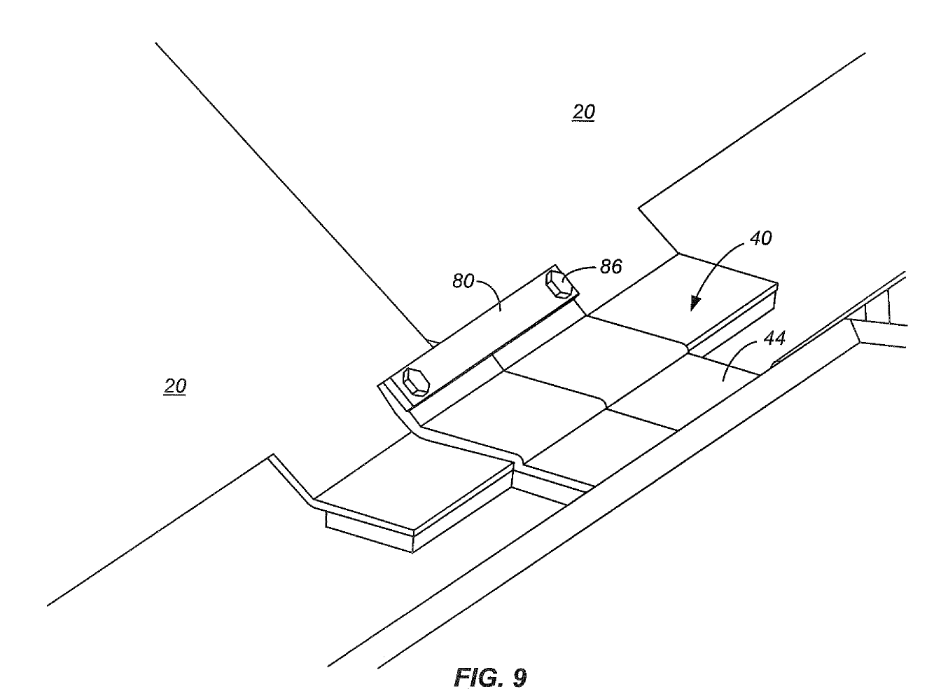

Rear support assembly 56 of FIGS. 11-13 comprises wind deflector assembly 58 and connections 62. Wind deflector assembly 58 comprises rear wind deflector 20 and a bracket 90. Connection 62 is formed at the upper end 92 of bracket 90. Rear wind deflector 20 is pivotally secured to the lower end 94 of bracket 90 at a pivot 96. Foot 70 extends from lower edge 84 of rear wind deflector 20. Offset distal end 52 may be secured to lower edge 84 using connector element 80 and screws 86 as shown in FIG. 9.

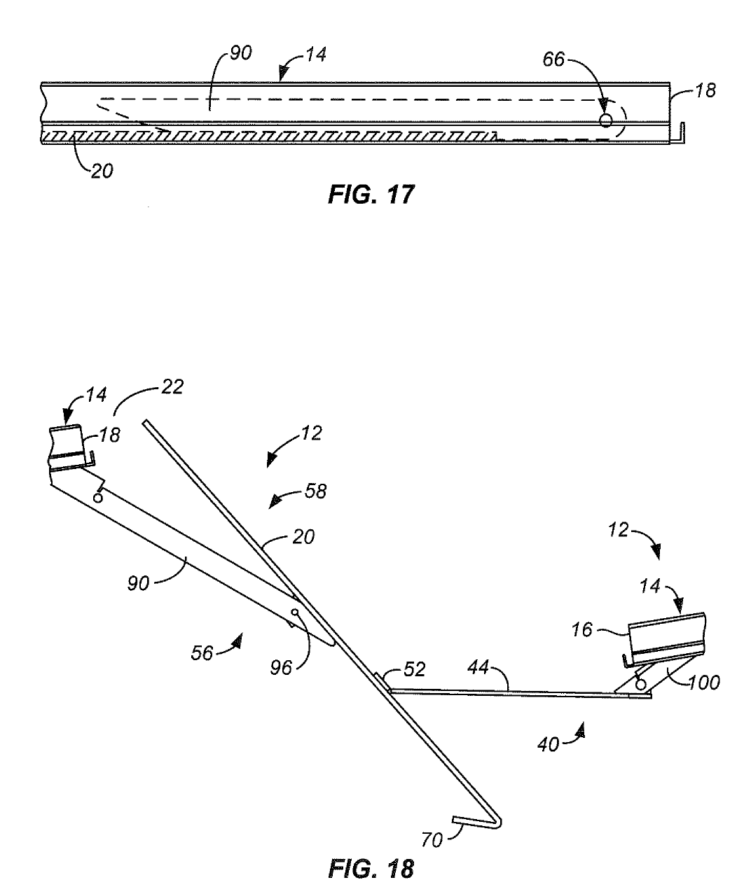

FIGS. 11-13 illustrate PV assembly 12 in a use orientation. Lower surface 82 of PV module 14 and peripheral edge 38 define a PV module interior 98. FIG. 17 shows rear support assembly 56 folded back against PV module 14 in a storage orientation. Rear support assembly 56 is effectively completely within PV module interior 98 when the storage orientation; this is illustrated somewhat schematically in FIG. 17.

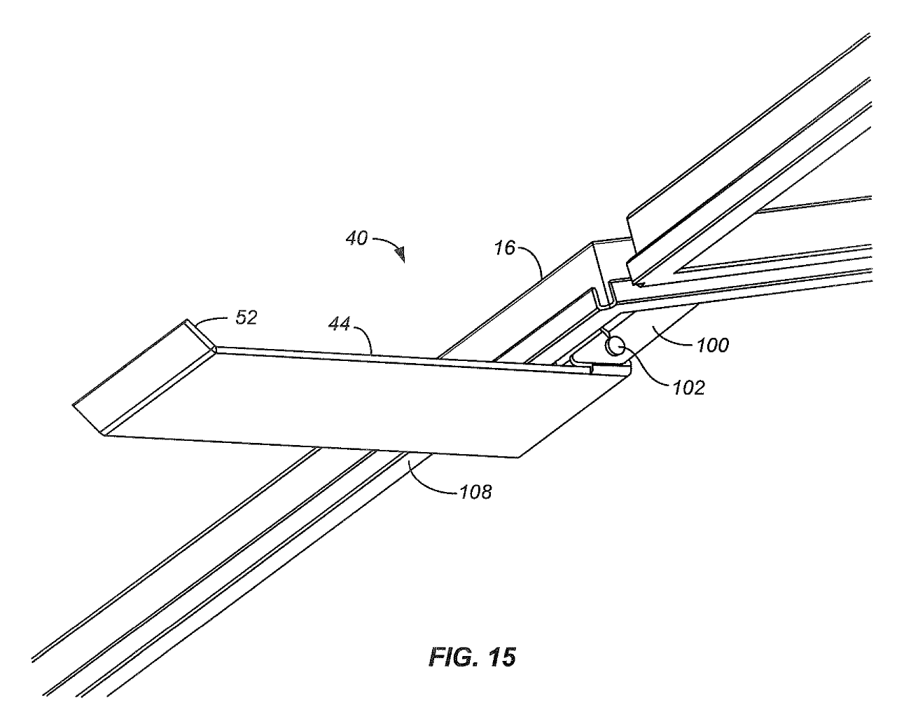

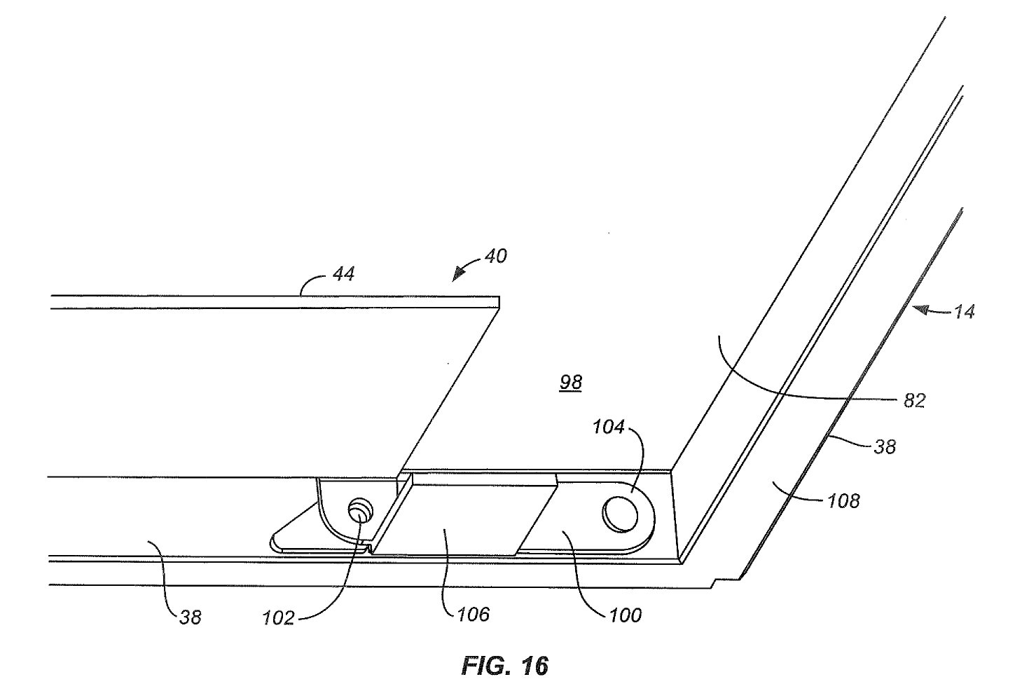

FIGS. 11 and 15 illustrate front support 40 in a use orientation. The base 44 of front support 40 is pivotally connected to a link 100 of front support 40 at a pivot 102. Link 100 is pivotally connected to peripheral edge 38 at a pivot 104 shown in FIGS. 11 and 16. A stop element 106 extends laterally from link 100 and limits the pivotal movement of the link in the use orientation by engaging the lower surface 108 (see FIGS. 15 and 16) of peripheral edge 38. As shown in FIG. 16, in the storage orientation front support 40 is also effectively completely within PV module interior 98.

FIG. 18 illustrates a still further embodiment of the invention with like reference numerals referring to like elements. PV assembly 12 is similar to the embodiment of FIG. 11 with one primary difference. Pivot 96 is located midway along rear wind deflector 20 and offset distal end 52 of base 44 of front support 40 is located above foot 70. Doing so raises the elevation of lower front edge 16 of PV module 14 thus changing its angle. Therefore, by adjusting the position at which offset distal and 52 is secured to rear wind deflector 20, the angle of inclination of PV module 14 can be easily changed.

The embodiments of FIGS. 11-18 provide several significant advantages for the user. One advantage is that all components of PV assembly 12 can be shipped connected to one another. The only extra components would be interconnecting structure, such as connector elements 80 and screws 86, used to secure PV assemblies 12 to one another. This can greatly simplify shipping and on-site assembly because the user needs to only fold out front suppon 40 and rear support assembly 56 and place assembly 12 on a support surface. Another advantage is that when PV assembly 12 is in the storage orientation, the PV assembly occupies effectively the same volume as PV module 14. In addition to increasing the packing efficiency for PV assemblies 12 during storage and transport, PV assemblies 12 may be able to be stored and shipped in the same packaging that was used for shipping PY modules 14 without front support 40 or rear support assembly 56. Doing so reduces packaging waste and helps to reduce the final cost of the product.

While the angle of rear wind deflector 20 could be made to be adjustable, a preferred embodiment uses a fixed angle, the angle typically being chosen according to the inclination, if any, of support surface 48 and the latitude of the site. It is preferred that PV assemblies 12 be mounted without the use of support-surface-penetrating screws, nails, etc. If necessary or desirable, ballast can be used to help counteract wind uplift forces. One way to do so would be to provide the underside of rear wind deflector 20 with L-shaped clips to permit pavers or other ballast to be mounted to and beneath the rear wind deflectors. The weight of PV assemblies 12, including any ballast, is preferably less than 3 pounds per square foot. Depending on various factors, such as expected maximum wind speeds, regulatory requirements and configuration of the roof or other support surface, the weight of PV assemblies 12 in various embodiments may be less than 3 pounds per square foot (144 N per square meter), less than 5 pounds per square foot (239 N per square meter), less than 10 pounds per square foot (479 N per square meter), or less than 15 pounds per square foot (718 N per square meter).

In use, stacks of PV assemblies 12 are preferably delivered to the worksite in a folded condition as one-piece assemblies. After a PV assembly 12 has been removed from its packaging, rear support assembly 56 and front support 40 are moved from their storage orientations to their use orientations. After being properly located on support surface 48, adjacent PV assemblies 12 can be secured to one another using, for example, connector elements 80 and screws 86. Electrical connections are made among PV assemblies 12 and side wind deflectors 28 are installed to complete the installation.

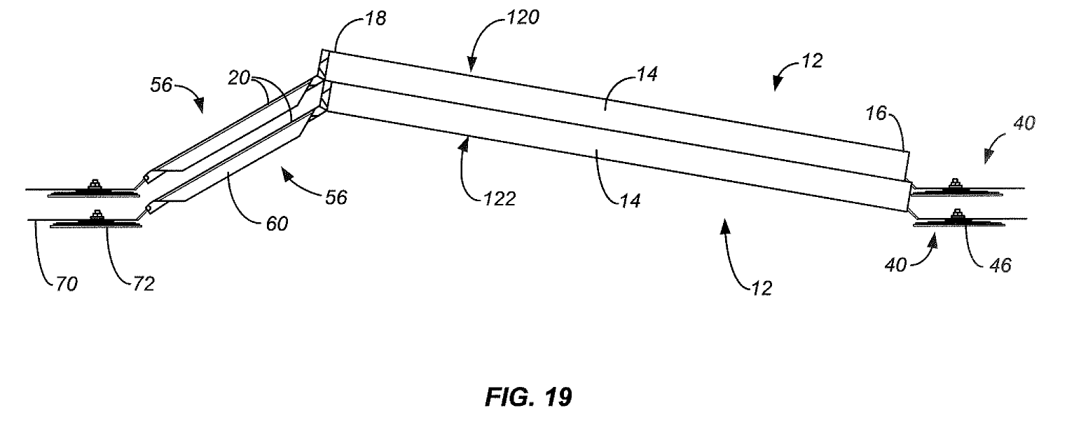

In a further embodiment, shown in FIG. 19, PV assembly 12 is not necessarily foldable but is constructed to be a one-piece, nesting PV assembly. The first, upper and second, lower PV assemblies 12 of FIG. 19 are shown in a nesting, transport mode. This close packing density is possible because PV assembly 12 of the FIG. 19 embodiment has complementary top and bottom surface profiles 120, 122. In this way the rear support assembly 56, PV module 14 and front support 40 of adjacent PV assemblies 12 can be positioned adjacent to one another when in the nesting, transport mode. In one embodiment, as illustrated in FIG. 19, PV modules 14 touch one another when in the nesting, transport mode so that the height of the PV modules determines the packing density. In other embodiments it may be desired to use small spacers between portions of adjacent PV assemblies 12, such as between adjacent PV modules 14.

The above descriptions may have used terms such as above, below, top, bottom, over, under, et cetera. These terms are used to aid understanding of the invention are not used in a limiting sense.

Other modification and variation can be made to the disclosed embodiments without departing from the subject of the invention as described above, shown in the accompanying drawing and defined in following claims. For example, in some embodiments it may be desired to secure one or both of rear support assembly 56 and front support 40 to PV module 14 using other than a pivot connection, such as a tool-less clip or a snap in place connection; in such event it would still be preferred that rear support assembly 56 and front support 40 be secured to PV module 14 to lie along lower surface 82 of the PV module, and preferably within interior 98, during shipping and storage. Also, it may be desired to construct an embodiment of PV assembly 12 so that rear wind deflector 20 is attached to the remainder of the assembly in the field. For example, in the embodiment of FIGS. 1-7 rear wind deflector 20 may be constructed to be attached to legs 60 in the field.

Any and all patents, patent applications and printed publications referred to above are incorporated by reference.

What is claimed is:

1. A one-piece, collapsible PV assembly comprising:
a PV module comprising front and rear edges on opposite sides thereof, an upper surface and a lower surface;
a front support secured to the PV module at the front edge and having a first support-surface-engaging surface; and
a rear support assembly comprising:
a wind deflector assembly having first and second end portions, the wind deflector assembly comprising a wind deflector;
a connection securing the first end portion to the PV module at the rear edge to permit the wind deflector assembly to be placed in a use orientation, extending downwardly and outwardly away from the rear edge, and a storage orientation, extending along the lower surface of the PV module; and
the second end portion of the wind deflector assembly comprising a second support-surface-engaging surface.

2. The assembly according to claim 1 wherein the wind deflector assembly comprises a bracket, the bracket comprising the connection securing the first end portion of the wind deflector to the PV module, the bracket secured to and extending from the wind deflector.

3. The assembly according to claim 1 wherein the wind deflector assembly comprises a leg, the leg comprising the first and second end portions, the wind deflector mounted to the leg.

4. The assembly according to claim 1 wherein the wind deflector assembly comprises legs, the wind deflector being mountable to the legs in the field.

5. The assembly according to claim 1 wherein the connection comprises a pivot connection pivotally securing the first end portion of the wind deflector assembly to the PV module at the rear edge, whereby the one-piece, collapsible PV assembly is a one-piece, folding PV assembly.

6. The assembly according to claim 1 wherein the front support is pivotally connected to the PV module for movement between a use orientation, extending outwardly away from the front edge, and a storage orientation, extending along the lower surface of the PV module.

7. The assembly according to claim 1 wherein the PV module comprises a peripheral edge, the peripheral edge and the lower surface defining a PV module interior, the rear support assembly being effectively completely within the PV module interior when the wind deflector assembly is placed in the storage orientation.

8. The assembly according to claim 7 wherein the front support is pivotally connected to the PV module for movement between a use orientation, extending outwardly away from the front edge, and a storage orientation, extending along the lower surface of the PV module, the front support being effectively completely within the PV module interior when in the storage orientation.

9. The assembly according to claim 1 wherein the PV module is at a tilt angle of between 1-35° when the wind deflector assembly is in the use orientation.

10. The assembly according to claim 1 wherein the PV module is at a tilt angle of between 1-20° when the wind deflector assembly is in the use orientation.

11. The assembly according to claim 1 wherein the PV module is at a fixed tilt angle when the wind deflector assembly is in the use orientation.

12. A PV installation comprising:
a support surface;
a plurality of PV assemblies made according to claim 1 on the support surface adjacent to one another; and
connector elements securing adjacent PV assemblies to one another.

13. The PV installation according to claim 12:
wherein the PV assemblies comprise an array of PV assemblies, the array comprising rows of PV assemblies, the rows having ends; and
further comprising side wind deflectors at the ends of the rows of PV assemblies.

14. The PV installation according to claim 13 wherein each of the PV assemblies is secured to at least one other PV assembly.

15. The assembly according to claim 1 wherein the PV assembly has a weight of less than 718 N per square meter.

16. The assembly according to claim 1 wherein the PV assembly has a weight of less than 479 N per square meter.

17. The assembly according to claim 1 wherein the PV assembly has a weight of less than 239 N per square meter.

18. The assembly according to claim 1 wherein the PV assembly has a weight of less than 144 N per square meter.

19. A one-piece, folding PV assembly comprising:
a PV module comprising a peripheral edge, the peripheral edge comprising front and rear edges on opposite sides thereof an upper surface and a lower surface, the peripheral edge and the lower surface defining a PV module interior;
a front support secured to the PV module at the front edge and having a first support-surface-engaging surface, the front support being pivotally connected to the PV module for movement between a use orientation, extending outwardly away from the front edge, and a storage orientation, extending along the lower surface of the PV module, the front support being effectively completely within the PV module interior when in the storage orientation; and
a rear support assembly comprising:
a wind deflector assembly having first and second end portions, the second end portion of the wind deflector assembly comprising a second support-surface-engaging surface; and
a pivot connection pivotally securing the first end portion to the PV module at the rear edge to permit the wind deflector assembly to be placed in a use orientation, extending downwardly and outwardly away from the rear edge, and a storage orientation, extending along the lower surface of the PV module, the rear support assembly being effectively completely within the PV module interior when the wind deflector assembly is placed in the storage orientation.

20. A method for installing an array of PV assemblies on a support surface;
receiving a plurality of folded PV assemblies at a worksite in folded, storage orientations, said PV assemblies each comprising a PV module having a lower surface, a front support and a rear support assembly comprising a wind deflector, the rear support assembly pivotally connected to the PV module and extending along the lower surface of the PV module in the storage orientation;
transforming at least one of said PV assemblies from a storage orientation to a use orientation by:
pivoting the rear support assembly downwardly and outwardly away from the lower surface of the PV module; and:
arranging the front support to extend outwardly away from the PV module; and
positioning said at least one PV assembly in the use orientation on the support surface.

21. The method according to claim 20 wherein the receiving step comprises receiving the plurality of one-piece folded PV assemblies with the front support pivotally connected to the PV module and extending along the lower surface in the storage orientation; and
the transforming step comprises pivoting the front support downwardly and outwardly away from the PV module.

22. The method according to claim 21 wherein the receiving step is carried out with the PV module having a peripheral edge, the peripheral edge and the lower surface defining a PV module interior, the front support and the rear support assembly being effectively completely within the PV module interior when in the storage orientation.

23. The method according to claim 20 wherein the receiving step is carried out with the PV module having a peripheral edge, the peripheral edge and the lower surface defining a PV module interior, the rear support assembly being effectively completely within the PV module interior when in the storage orientation.

24. A method for preparing and installing an array of PV assemblies on a support surface;
shipping a plurality of PV modules in packaging, the PV modules having a lower surface:
removing the PV modules from the packaging;
repackaging PV assemblies in the packaging in a folded, storage orientation, said PV assemblies each comprising said PV module and a rear support assembly comprising a wind deflector, the rear support assembly pivotally connected to the PV module and extending along the lower surface of the PV module in the storage orientation;
transporting the PV assemblies in the same packaging used for shipping the PV modules;
receiving a plurality of the transported PV assemblies at a worksite in the folded, storage orientations;
removing the PV assemblies from the packaging;
transforming at least one of said PV assemblies from the folded, storage orientation to an unfolded, use orientation by:
pivoting the rear support assembly downwardly and outwardly away from the lower surface of the PV module; and:
arranging a front support to extend outwardly away from the PV module; and
positioning said at least one PV assembly in the use orientation on the support surface.

25. The method to according to claim 24 further comprising repeating the transforming and positioning steps for a plurality of said PV assemblies to form an array of PV assemblies on the support surface.

26. A method according to claim 25 further comprising securing the PV assemblies of the array of PV assemblies to one another.

27. The method according to claim 26 wherein the securing step is carried out using connector elements.

28. The method according to claim 26 wherein the securing step is carried out with connector means for preventing lateral separation between adjacent PV assemblies while permitting said PV assemblies to follow the contour of an other-than-flat support surface.

29. The method according to claim 28 wherein the repackaging step is carried out with the front support pivotally secured to the PV module and extending along the lower surface of the PV module in the storage orientation, and the front support arranging step carried out by pivoting the front support downwardly and outwardly away from the lower surface of the PV module.

30. The method according to claim 24 wherein the repackaging step is carried out with said PV assemblies each comprising the front support associated with the PV module.

31. The method according to claim 24 wherein the repackaging step is carried out with the front support pivotally secured to the PV module and extending along the lower surface of the PV module in the storage orientation, and the front support arranging step carried out by pivoting the front support downwardly and outwardly away from the lower surface of the PV module.

32. A one-piece, nesting PV assembly comprising:
a PV module comprising front and rear edges on opposite sides thereof, an upper surface and a lower surface;
a front support secured to the PV module at the front edge and having a first support-surface-engaging surface, the front support extending outwardly away from the front edge;
a rear support assembly comprising:
a wind deflector assembly having first and second end portions, the wind deflector assembly comprising a wind deflector;
the second end portion of the wind deflector assembly comprising a second support-surface-engaging surface; and
the first end portion secured to the PV module at the rear edge, the rear support assembly extending downwardly and outwardly away from the rear edge; and
the PV assembly having complementary nestable top and bottom surface profiles to permit first and second of the PV assemblies to stack in a nesting fashion in a transport mode with the PV module, front support and rear support assembly of the first PV assembly adjacent to the corresponding structure of the second PV assembly thereby maximizing packing density.

33. The PV assembly according to claim 32 wherein the PV modules of the first and second PV assemblies touch one another when in the transport mode.
